(19) United States
(12) Patent Application Publication
(10) Pub. No.: US 2026/0230011 A1
(43) Pub. Date: Aug. 6, 2026

(54) MULTIPLE PULSE INITIALIZATION OF A BLDC MOTOR ENCODER

(71) Applicant: Robert Bosch GmbH, Stuttgart (DE)

(72) Inventor: Richard R. Myers, Lititz, PA (US)

(21) Appl. No.: 19/042,414

(22) Filed: Jan. 31, 2025

(51) Int. Cl. H02P 1/04; H02P 1/18; H02P 6/08

(52) U.S. Cl. CPC H02P 1/04; H02P 1/18; H02P 6/08

(57) ABSTRACT

Systems and methods directed to a device that may determine a first encoder count for an encoder equivalent to a 90-degree rotation of the rotor. The device may energize the stator with a power source to rotate the rotor based on the first encoder count from a known position to a final position. The device may determine, with an electronic processor, a friction error sweep angle equivalent to a difference between a desired initiation position and the final position of the rotor. The device may adjust, with the electronic processor, the first encoder count based on the friction error sweep angle to define a second encoder count. The device may start the motor by energizing the stator with the power source to rotate the rotor based on the second encoder count.

### FIELD

This application relates to the field of motor control and more specifically to controlling a BLDC (brushless direct current) motor with a relative encoder.

### BACKGROUND

A BLDC motor may be driven by a field-oriented control (FOC) algorithm. A generated stator flux interacts with the rotor flux, which is generated by a rotor magnet and defines a torque and therefore the speed of the motor. The voltage strokes/pulses must be properly applied so that the angle between the stator flux and the rotor flux is kept as close to perpendicular (90 degrees) as possible, to get the maximum generated torque.

For proper operation of a BLDC motor, the orientation of the stator with respect to the rotor must change to maintain as close to a perpendicular flux relationship as possible. A stator flux vector must be changed at specific rotor positions to maintain this relationship. The orientation of the rotor is usually sensed by Hall sensors.

With an FOC algorithm, a relative encoder can replace the hall sensors and provide a precise relative position but does not provide an absolute or actual position.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate aspects, examples, aspects, and features of concepts that include the claimed subject matter and explain various principles and advantages of those aspects, examples, aspects, and features.

FIG. 1 illustrates a motor control system for a motor with an encoder according to some aspects.

FIG. 2 is a schematic cross-section of the motor taken along line II-II of FIG. 1.

FIG. 3 is a schematic cross-section of the motor illustrating a four-pulse method of aligning the motor with a desired initiation position.

FIG. 4 illustrates an example method of operating the motor.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, aspects, and features illustrated.

In some instances, the apparatus and method components have been represented where appropriate by conventional symbols in the drawings, showing only those specific details that are pertinent to understanding the of various aspects, examples, aspects, and features so as not to obscure the disclosure with details that will be readily apparent to those of ordinary skill in the art having the benefit of the description herein.

### DETAILED DESCRIPTION

Encoders output values that are either absolute or relative. Relative encoders are more prevalent as they are significantly less expensive and require less complex components. As will be described in more detail herein, multi-pulse initialization of a relative type of encoder for a BLDC motor results in increased accuracy for determining an actual initialization position. Further, the method described herein provides, among other things, quantitative data regarding the amount of friction in a BLDC motor system. BLDC motors rely on electronic commutation to control the direction of the magnetic field which can be managed with the relative type of encoder. If an initialization position for the encoder is determined to be inaccurate, the motor may not receive the necessary signals to properly regulate its speed which may result in uncontrolled acceleration, or a “runaway motor”.

BLDC motors with encoders are used in multiple applications including security cameras for controlling the pan and tilt of a multi-axis moveable camera. A runaway motor would render a security camera inaccurate, and in some cases inoperable. Therefore, it is desirable to have a reliable method for determining the actual initialization position for the encoder. Determining the actual initialization position will avoid a runaway motor and also reduce or eliminate an error due to frictional elements in the BLDC motor system. Additionally, determination of the actual initialization position results in a reduction in power needed to run the motor because an orthogonal relationship between magnetic fields of the stator and rotor is more accurately achieved.

In some aspects, the techniques described herein relate to a method of operating a motor, the motor having a stator and a rotor, the rotor rotatable about a motor axis. The method includes determining a first encoder count for an encoder equivalent to a 90-degree rotation of the rotor. The method includes energizing the stator with a power source to rotate the rotor based on the first encoder count from a known position to a final position. The method includes determining, with an electronic processor, a friction error sweep angle equivalent to a difference between a desired initiation position and the final position of the rotor; adjusting, with the electronic processor, the first encoder count based on the friction error sweep angle to define a second encoder count. The method includes starting the motor by energizing the stator with the power source to rotate the rotor based on the second encoder count.

In some aspects, the techniques described herein relate to a motor control system including a motor having a stator and a rotor, the stator including stator windings, the rotor rotatable about a motor axis. The motor control system includes an encoder associated with a first encoder count equivalent to a 90-degree rotation of the rotor; and an electronic processor. The electronic processor is configured to energize the stator from a power source to rotate the rotor based on the first encoder count from a known position to a final position. The electronic processor is configured to determine a friction error sweep angle equivalent to a difference between a desired initiation position and the final position of the rotor. The electronic processor is configured to adjust the first encoder count based on the friction error sweep angle to define a second encoder count. The electronic processor is configured to start the motor by energizing the stator with the power source to rotate the rotor based on the second encoder count.

In some aspects, the techniques described herein relate to a non-transitory computer-readable medium for aligning a motor to a desired initiation position, the motor having a stator and a rotor, the stator including a first set of stator windings and a second set of stator windings, the rotor rotatable about a motor axis. The non-transitory computer-readable medium including instructions executable by an electronic processor to perform a set of functions. The set of functions including determining, with an electronic processor, a first encoder count equivalent to a 90-degree rotation of the rotor. The set of functions including energizing the stator with a power source to rotate the rotor based on the first encoder count from a known position to a final position. The set of functions including determining, with the electronic processor, a friction error sweep angle equivalent to a difference between a desired initiation position and the final position of the rotor. The set of functions including adjusting, with the electronic processor, the first encoder count based on the friction error sweep angle to define a second encoder count. The set of functions including starting the motor by energizing the stator with the power source to rotate the rotor based on the second encoder count.

Before any aspects, features, or instances are explained in detail, it is to be understood that the aspects, features, or instances are not limited in their application to the details of construction and the arrangement of components set forth in the following description or illustrated in the following drawings. Other instances are possible and are capable of being practiced or of being carried out in various ways.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Also, it is to be understood that the phraseology and terminology used herein is for the purpose of description and should not be regarded as limiting. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

For ease of description, some or all of the example systems presented herein are illustrated with a single exemplar of each of its component parts. Some examples may not describe or illustrate all components of the systems. Other instances may include more or fewer of each of the illustrated components, may combine some components, or may include additional or alternative components.

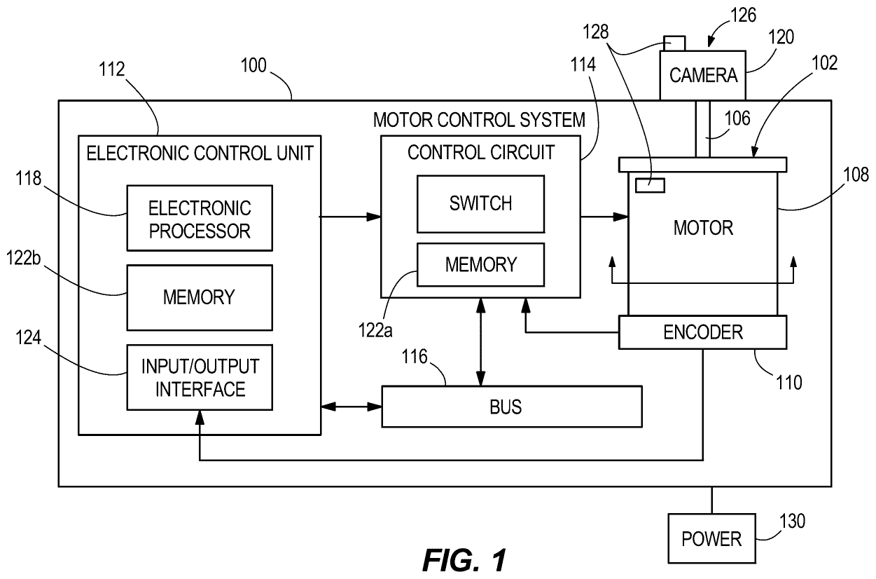

FIG. 1 illustrates a motor control system 100 for a motor 102 having a rotor 106, a stator 108, and a relative encoder, referred to herein as encoder 110, according to some aspects. In some instances, the motor 102 is a 3-phase brushless direct current motor (BLDC). In one example the motor 102 is used to control movement of the pan or tilt of a camera 120. In the example illustrated, the motor control system 100 includes an electronic control unit (ECU) 112 and a control circuit 114. The control circuit 114 may include one or more memory locations 122a. The components of the motor control system 100, along with other various modules and components are electrically and communicatively coupled to each other via direct connections, or via, or through, one or more control or data buses (for example, bus 116), which enable communication therebetween. In some instances, the bus 116 is a serial peripheral interface (SPI) or an I squared C (I2C). In some instances the bus 116 is a controller area network (CAN) bus. In some instances, the bus 116 is an automotive Ethernet, a FlexRay™ communications bus, or another suitable bus. In alternative instances, some or all of the components of the motor control system 100 may be communicatively coupled using suitable wireless modalities (for example, Bluetooth™ or near field communication connections).

The motor control system 100 may be a closed loop system where the encoder 110 is associated with the motor 102. In one example the encoder 110 is mounted to a back of the motor 102. In some examples the encoder 110 is made up of a thin disc with lines on it. The disc passes between a transmitter and a receiver. Each time a line comes between the two, a pulse is output on the signal lines. These pulses may be fed back to the control circuit 114 which adjusts drive currents in the motor 102. Usually, at the end of the move the ECU 112 compares the number of pulses sent to the driver with the number of encoder pulses sent back. A routine is usually written that if the two numbers are different, the difference is then made up. If the numbers are the same, no error has occurred, and motion continues. In some examples the encoder 110 outputs data directly to the control circuit 114, allowing for the control circuit 114 to more rapidly adjust current provided to the motor 102. In other examples output data is sent to the ECU 112.

The ECU 112 includes an electronic processor 118, a memory 122b, and an input/output interface 124. In some examples, the electronic processor 118 is implemented as a microprocessor with separate memory, for example the memory 122a. In other examples, the electronic processor 118 may be implemented as a microcontroller (with memory on the same chip). In other examples, the electronic processor 118 may be implemented using multiple processors. In addition, the electronic processor 118 may be implemented partially or entirely as, for example, a field-programmable gate array (FPGA), an applications specific integrated circuit (ASIC), and the like and the memory 122b may not be needed or be modified accordingly.

The input/output interface 124 may include one or more input mechanisms and one or more output mechanisms (for example, general-purpose input/outputs (GPIOs), analog inputs, digital inputs, and others). The input/output interface 124 may include one or more user inputs (for example, a wireless command to tilt or pan the camera 120) for a user to provide input to the motor control system 100 to control one or more operations of the motor 102.

The input/output interface 124 may also include other input and output mechanisms, which for brevity are not described herein and which may be implemented in hardware, software, or a combination of both. For example, in some aspects, the input/output interface 124 includes a transceiver (not shown) communicating data over one or more wireless communications networks (for example, cellular networks, satellite networks, land mobile radio networks, etc.). The transceiver may also provide wireless communications within the motor control system 100 using suitable network modalities (for example, Bluetooth™, near field communication (NFC), Wi-Fi™, and the like). Accordingly, the transceiver may communicatively couple the ECU 112 and other components of the motor control system 100 with networks or electronic devices both inside and outside the motor 102 to send and receive data, commands, and other information. Some aspects include multiple transceivers or separate transmitting and receiving components (for example, a transmitter and a receiver) instead of a combined transceiver.

In some examples, the memories 122a, 122b includes non-transitory, computer-readable memory that stores instructions that are received and executed by the electronic processor 118 to carry out methods described herein. The memories 122a, 122b may include, for example, a program storage area and a data storage area. The program storage area and the data storage area may include combinations of different types of memory, for example read-only memory and random-access memory.

The motor control system 100 and camera 120 may be part of a security surveillance system 126 including additional cameras (not shown) each attached to a motor 102 as described herein. It should be understood that while described in regard to a BLDC motor for operating a camera 120 for the security surveillance system 126, other applications regarding the motor control system 100 are contemplated.

The motor control system 100 may include one or more sensors 128 configured to measure one or more characteristics of one or more components for the motor 102 and/or the camera 120 and/or an environment surrounding the camera 120. In some aspects, one or more of the sensors 128 may be integrated into the motor 102, by way of example the encoder 110. In yet another example, the sensors 128 may be integrated into other parts of the motor 102 and/or the security surveillance system 126 and include by way of example, one or more of a speed sensor, a rotational position sensor, an inertia movement sensor, a pressure sensor, a voltage sensor, a current sensor, a radar, an image sensor, and the like.

The motor control system 100 is connected to a power source 130, the power source 130 may be any suitable power source, including a DC power source. The electronic processor 118 may be configured to send a signal to the power source 130 to energize the stator 108. It is further contemplated that the control circuit 114 sends a signal to the power source 130 to energize the stator 108. Further, any combination of signal sources from the electronic processor 118 or the control circuit 114 for energizing the stator 108 is contemplated.

The ECU 112 may be configured to receive information from the encoder 110 and actively control the motor 102 based on the received information. While not described herein, it should be understood that the ECU 112 may be configured to receive additional information from the one or more sensors 128 relating to the security surveillance system (for example, via the CAN bus 116) and actively control the motor and in turn movement of the camera 120 on the received information. A field-oriented control (FOC) algorithm for controlling the motor may be stored in the memory 122b of the electronic control unit 112.

It is further contemplated that the control circuit 114 receives information directly from the encoder 110 to actively control the motor 102 and that the FOC algorithm is stored in the memory 122a of the control circuit 114.

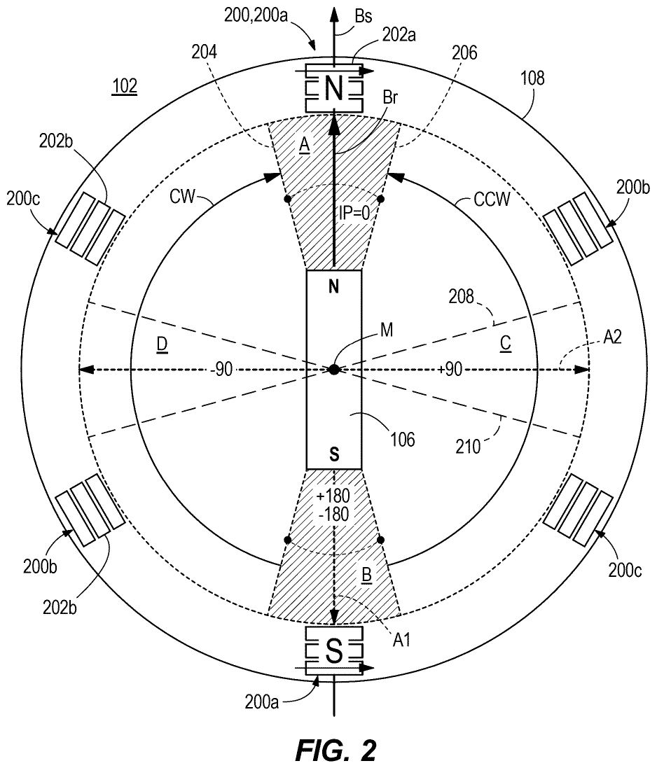

FIG. 2 is a schematic cross-section taken along line II-II of FIG. 1. The stator 108 is made up of three pairs of stator windings 200, a first pair 200a, a second pair 200b, and a third pair 200c. The three pairs of stator windings 200 define the 3-phase BLDC motor 102. The first pair 200a defines a first set of stator windings 202a oriented along a first axis (“A1”). The second and third pairs 200b, 200c define a second set of stator windings 202b oriented along a second axis (“A2”) perpendicular to the first axis A1. While illustrated with the first set of stator windings 202a including the first pair 200a and the second set of stator windings 202b including the second and third pairs 200b, 200c of stator windings 200, any number of stator windings are contemplated that can be used to generate orthogonal magnetic fields to cause rotation of the rotor 106. The stator windings 200 are electrically connected to the power source 130 for receiving a voltage, or “pulse”, to create a stator electromagnetic field (“Bs”). The rotor 106 is illustrated as a permanent magnet rotatable about a motor axis (“M”) and creating a rotor magnetic field (“Br”). While illustrated as a single permanent magnet, it should be understood that the rotor 106 can include multiple magnets in various known configurations including central to the stator windings 200 or circumscribing the stator windings 200. In order to properly implement a field-oriented control (“FOC”) of a BLDC motor, an exact alignment between the encoder 110 and a desired initialization position of IP=0° is advantageous. Aligning the encoder 110 at IP=0° provides a known initiation position for pulsing the motor 102 to rotate, and therefore properly control the motor 102 and camera 120.

Torque produced by energizing the stator windings 200 is maximum when the rotor magnetic field Br is perpendicular to the stator electromagnetic field Bs. For proper operation of the motor 102, it is desirable to keep the angle between flux generated by the stator 108 and flux from the rotor 106 as close to perpendicular as possible. When the stator electromagnetic field Bs from the first set of stator windings 202a is aligned with the rotor magnetic field Br, as illustrated, the torque generated is minimized, or equal to zero. When the torque generated is zero, no movement of the rotor 106 occurs which equates to no movement of the encoder 110.

Due to internal friction in the motor 102, there are two starting positions for the rotor 106, IP=0° and +/−180°, that will result in a stuck rotor when the first set of stator windings 202a are pulsed to begin rotation of the rotor 106. Further, even when the rotor magnetic field Br is located anywhere within two sector areas labeled “A” and “B” surrounding IP=0° and +/−180°, the amount of torque generated is too small to overcome the internal friction.

A single pulse method for aligning the rotor 106 with the desired initiation position IP=0° includes application of a voltage from the control circuit 114 to energize the first set of stator windings 202a and create the stator electromagnetic field Bs. In most cases, the stator electromagnetic field Bs results in an alignment of the encoder 110 and the rotor 106 with the stator electromagnetic field Bs. However, using the single pulse method may cause issues if the starting position for the rotor 106 is located in sector areas A or B. In some cases, the initialization position has been found to be incorrect by approximately 180 electrical degrees because the rotor is stuck and starting in sector area B. In this starting position, while aligned, the north (“N”) and south (“S”) poles of the rotor 106 are 180 degrees off causing an incorrect initialization position of +/−180° rather than IP=0°. This will cause a reversal of feedback to the control circuit 114 and result in a runaway motor. The control circuit 114 expects that the N pole is aligned at the winding in sector area A. Therefore, with the initialization done and the FOC algorithm ready to begin, if the control circuit 114 is directed to rotate the rotor 106 in a first direction, or clockwise (“CW”) direction, an appropriate magnetic field is produced at 90° to attract the N pole in the CW direction toward sector area C. However, when the N pole is actually in sector B, the magnetic field in sector C will attract the N pole and cause the rotor 106 to move in a second direction opposite the first direction, or counter-clockwise (“CCW”) direction. The control circuit 114 with the FOC algorithm will increase torque because the motor 102 has not moved in the first direction. The control circuit 114 will continue to generate a magnetic field in the wrong location, but with increasing torque. This results in the runaway motor, where rotation of the motor 102 is in the wrong direction and at a maximum possible speed.

Further, if during the single pulse method, the rotor 106 starting position is outside of sector areas A or B, as the rotor 106 spins in the first or second direction towards sector area A, the generated torque decreases and approaches zero. When the torque value decreases below the internal friction value, the rotor 106 will come to a stop. Therefore, unless the momentum of the rotor 106 is great enough to rotate all the way to IP=0°, the single pulse method may result in multiple unaligned scenarios.

As described above, the single pulse method results in two stuck scenarios and four possible finishing general positions: anywhere in sector areas A or B, at a first edge 204 of sector area A, and at a second edge 206 of sector area A.

Another method for aligning the rotor 106 with the desired initiation position IP=0° is a two-pulse method. In the two-pulse method, two alignment pulses orthogonal to each other are implemented. In one example, a first pulse energizes the second set of stator windings 202b to generate a magnetic field located 90 degrees from the first set of stator windings 202a. It should be understood that when the second set of stator windings 202b is energized by a first pulse, as previously discussed herein, this will result in two stuck scenarios, labeled sector areas “C” and “D”, and four possible finishing positions: anywhere in sector areas C or D, at a first edge 208 of sector area C, and at a second edge 210 of sector area C.

To eliminate the stuck scenarios, a second pulse energizes the first set of stator windings 202a. This causes the rotor 106 to rotate in a second direction, e.g. CW or CCW, from the four possible finishing positions and align with either of the first edge 204 of sector area A, and the second edge 206 of sector area A.

While two pulses prevent the stuck scenarios, two ending positions are still a possibility. While the ending positions are close to a desired initiation position IP=0°, as previously discussed herein, the internal friction may cause the rotor 106 to stop before reaching IP=0°.

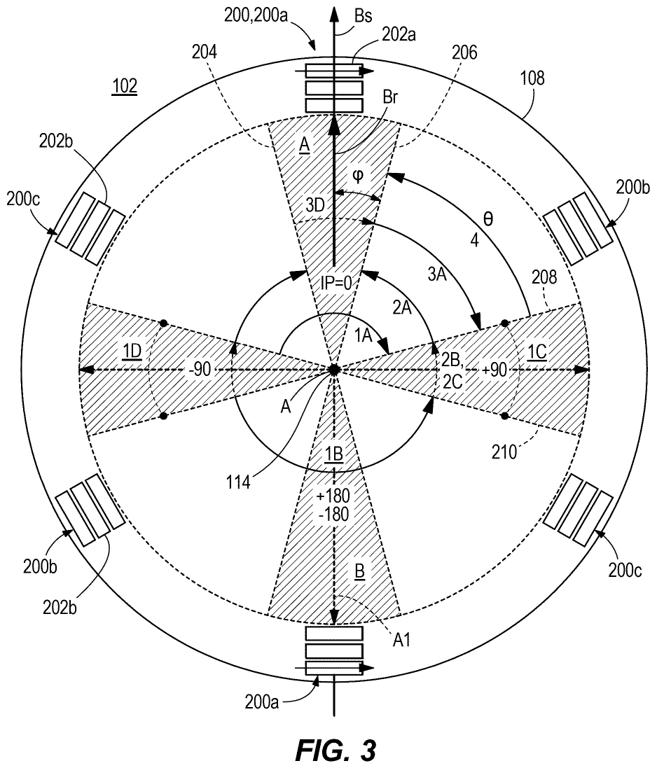

FIG. 3 is a schematic cross-section of the motor 102 illustrating a four-pulse method of aligning the encoder 110 with the desired initiation position IP=0°. The four-pulse method is more precise than the methods previously described herein, provides an accurate starting position, and also reduces error due to frictional elements in a BLDC motor.

The four-pulse method begins with the two-pulse method, where the encoder 110 (FIG. 1) and rotor 106 (FIG. 1) will rotate in the first direction, e.g. CW or CCW, along arc 1A or 1B or remain (stuck) in sector areas 1C, and 1D with a first pulse. A second pulse will cause the encoder 110 (FIG. 1) and rotor 106 (FIG. 1) to rotate in the second direction opposite the first direction, e.g. CCW along arcs 2A, 2B, and 2C, or CW along arc 2D, depending on the ending position from the first pulse.

As described previously herein, two pulses do not guarantee a known ending position, therefore a third pulse energizes the second set of stator windings 202b causing the encoder 110 (FIG. 1) and rotor 106 (FIG. 1) to rotate in the first direction, e.g. CW, along arc 3A or 3D, depending on the ending position from the second pulse, toward sector area 1C and end at the first edge 208 of sector area C to define a known position.

Upon completion of the third pulse, the encoder 110 (FIG. 1) and rotor 106 (FIG. 1) are now aligned at the first edge 208 of sector area C. With a fourth pulse the encoder 110 (FIG. 1) and rotor 106 (FIG. 1) will move in the second direction, e.g. CCW, from the first edge 208 of sector area C toward IP=0° along arc 4 to the second edge 206 of sector area A to define a final position. Due to internal friction the rotor does not line up with the stator magnetic axis, and therefore at no point during the four-pulse method is the rotor aligned directly at the desired initiation position IP=0°. Due to the internal friction, a final sweep angle (θ) defining arc 4 will have a value of less than 90 degrees. Design parameters for the encoder 110 and the motor 102 include information needed to calculate a first encoder count equivalent to a full 90 degrees of movement. In other words, how many pulses generated by the encoder is equivalent to a 90 degree turn of the rotor 106 (FIG. 1). The magnitude of the final sweep angle θ will be less than the full 90 degrees of movement by a magnitude of an amount that is twice a friction error sweep angle (φ) (see Equation 1):

$$θ = 90 ° - 2 φ \qquad ( Equation 1 )$$

In other words, a pulse required to overcome friction near IP=0° is the same on either side of IP=0°. The friction error sweep angle φ can therefore be calculated from the known information about the motor 102 and the encoder 110, and the final angle θ due to the fourth pulse (see Equation 2):

$$φ = \frac{90 ° - θ}{2} \qquad ( Equation 2 )$$

Upon determining the friction error sweep angle φ a second encoder count can be determined. The second encoder count takes into consideration the first encoder count and the friction error sweep angle φ. The friction error sweep angle φ is used to adjust the first encoder count at the final position 206. In some examples the friction error sweep angle φ is fed directly to the FOC algorithm where the second encoder count is determined. In another example, the second encoder count is determined and then the second encoder count is fed to the FOC algorithm.

By way of example, if the final sweep angle θ is 80 degrees (θ=80°), then the friction error sweep angle is 5 degrees (φ=5°). Assuming the encoder produces count “7” at the final position, without an adjustment due to friction, the FOC algorithm adjusts the encoder readings by −7. According to the FOC algorithm the rotor position is at IP=0°. In reality the rotor is at the final position 206, or 5 degrees, therefore the orientation of the stator electromagnetic field Bs and the rotor magnetic field Br is 85 degrees rather than the preferred 90 degrees. In this example, the motor will rotate, but not with a maximum torque, and therefore will not be as fast.

Utilizing the four-pulse method and adjusting for the internal friction, the encoder reading is adjusted by −7 plus the friction error sweep angle of 5 degrees (φ=5°), so instead of a −7 adjustment, the FOC algorithm is given a −2 adjustment. Therefore, at the final position of 206, the encoder reading is 7, the FOC algorithm adjusts by −2, and the position determined is the correct 5 degrees. By way of example, when starting the motor in a CW rotation, the FOC places a magnetic field at 95 degrees (5°+90°) to achieve the desired orthogonal relationship between the stator and rotor. The motor will start with a maximum torque.

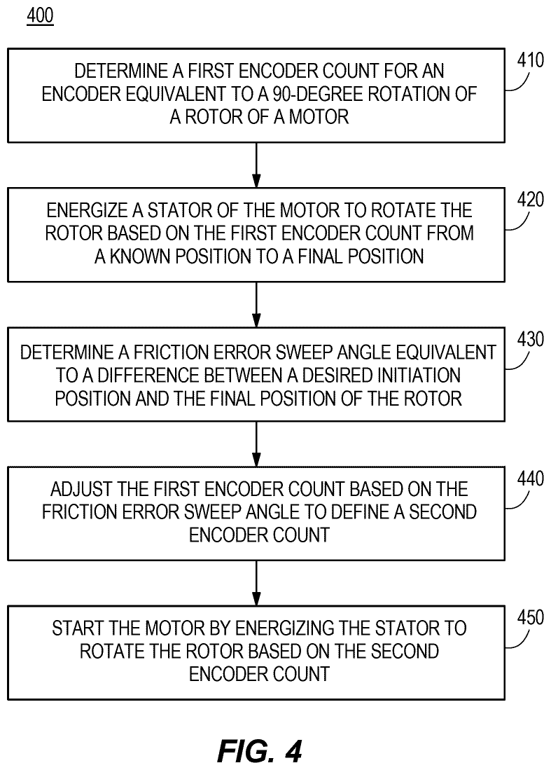

FIG. 4 illustrates an example method 400 for operating the motor 102. The method 400 is executed by, for example, the ECU 112. The ECU 112 executes software stored in the memory 122b to control the control circuit 114 in conjunction with other components (power supply, voltage or current source) of the motor control system 100. It is further contemplated that the method 400 is executed solely by the control circuit 114.

At step 410 the method 400 includes determining the first encoder count equivalent to a 90-degree movement of the encoder 110. The first encoder count may be predetermined and stored in either memory 122a or 122b or both.

At step 420 the method 400 includes energizing the stator windings 200 to rotate the rotor 106 based on the first encoder count from the known position, e.g. the first edge 208 of sector area C, to the final position, e.g. the second edge 206 of sector area A.

In rotating the rotor 106, the method 400 may also include rotating the encoder 110.

To rotate the rotor 106 from the known position to the final position, the four-pulse method is implemented. The four-pulse method includes first energizing with a first pulse the second set of stator windings 202b of the motor 102, then energizing with a second pulse the first set of stator windings 202a, and third energizing with a third pulse the second set of stator windings 202b. The third pulse causes the rotor 106 to rotate in the first direction to the first edge 208 of sector area C. Finally, the four-pulse method includes, energizing the first set of stator windings 202a with a fourth pulse to rotate the encoder 110 in the second direction to the second edge 206 of sector area A.

Energizing with the first pulse may cause the rotor 106 to rotate in the first direction to the first edge 208 of sector area C or to the second edge 210 of sector area C. Both locations are proximate a +90° from the desired initiation position IP=0°. The first edge 208 of sector area C is located CCW from the +90° a sweep angle equal to the friction error sweep angle. The second edge 210 of sector area C is located CW from the first edge 208 an amount twice the friction error sweep angle φ.

Energizing with the first pulse may also cause the rotor to remain stationary in sector area C between the first edge 208 and the second edge 210 of sector area C. The rotor 106 may also remain stationary within sector area D proximate −90° from the desired initiation position IP=0°. Both sector areas C and D cover a sweep angle equal to an amount twice the friction error sweep angle φ.

Energizing with the second pulse may causes the rotor 106 to rotate in the second direction opposite the first direction.

At step 430 the method 400 includes determining the friction error sweep angle q as previously described herein using Equation 2.

At step 440 the method 400 includes adjusting the first encoder count based on the friction error sweep angle φ to define the second encoder count.

At step 450 the method 400 includes starting the motor 102 by energizing the stator 108 to rotate the rotor 106 based on the second encoder count.

Thus, the systems and methods described herein provide for, among other things, position precision for a rotor in relationship to a stator for a motor (for example, a BLDC motor in the security surveillance system 126).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many aspects and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future aspects. In sum, it should be understood that the application is capable of modification and variation.

Various features and advantages of the aspects presented herein are set forth in the following claims.

What is claimed is:

1. A method of operating a motor, the motor having a stator and a rotor, the rotor rotatable about a motor axis, the method comprising:
determining a first encoder count for an encoder equivalent to a 90-degree rotation of the rotor;
energizing the stator with a power source to rotate the rotor based on the first encoder count from a known position to a final position;
determining, with an electronic processor, a friction error sweep angle equivalent to a difference between a desired initiation position and the final position of the rotor;
adjusting, with the electronic processor, the first encoder count based on the friction error sweep angle to define a second encoder count; and
starting the motor by energizing the stator with the power source to rotate the rotor based on the second encoder count.

2. The method of claim 1, wherein rotating the rotor comprises rotating the encoder.

3. The method of claim 1, wherein rotating the rotor from the known position to the final position comprises implementing a four-pulse method:
energizing a second set of stator windings of the motor with a first pulse from the power source,
energizing a first set of stator windings of the motor with a second pulse from the power source to rotate the rotor,
energizing the second set of stator windings with a third pulse from the power source to rotate the rotor in a first direction to the known position, and
energizing the first set of stator windings with a fourth pulse from the power source to rotate the rotor in a second direction opposite the first direction to the final position.

4. The method of claim 3, wherein the first pulse causes the rotor to rotate to a first edge or to a second edge of a sector area proximate a 90° location from the desired initiation position.

5. The method of claim 4, wherein the first edge is located a sweep angle equal to the friction error sweep angle from the 90° location in the second direction and the second edge is located a sweep angle equal to an amount twice the friction error sweep angle in the first direction from the first edge.

6. The method of claim 3, wherein the first pulse causes the rotor to remain stationary in one of a first sector area or a second sector area proximate +/−90° from the desired initiation position.

7. The method of claim 6, wherein both the first sector area and the second sector area cover a sweep angle equal to an amount twice the friction error sweep angle.

8. The method of claim 4, wherein the second pulse causes the rotor to rotate in the first direction or the second direction.

9. The method of claim 1, wherein a difference between the known position and the final position is a final sweep angle equivalent to 90-degrees minus twice the friction error sweep angle.

10. A motor control system comprising:
a motor having a stator and a rotor, the stator comprising stator windings, the rotor rotatable about a motor axis;
an encoder associated with a first encoder count equivalent to a 90-degree rotation of the rotor; and
an electronic processor configured to:
energize the stator from a power source to rotate the rotor based on the first encoder count from a known position to a final position;
determine a friction error sweep angle equivalent to a difference between a desired initiation position and the final position of the rotor;
adjust the first encoder count based on the friction error sweep angle to define a second encoder count, and
start the motor by energizing the stator with the power source to rotate the rotor based on the second encoder count.

11. The motor control system of claim 10, wherein the encoder is aligned with the motor and rotatable about the motor axis.

12. The motor control system of claim 10, wherein the motor control system controls a motor for at least one camera of a security surveillance system.

13. The motor control system of claim 10, wherein the motor is driven by a field-oriented control algorithm.

14. The motor control system of claim 10, wherein energizing the stator to rotate the rotor from the known position to the final position comprises implementing a four-pulse method including:
energizing a second set of stator windings of the motor with a first pulse from the power source,
energizing a first set of stator windings of the motor with a second pulse from the power source to rotate the rotor,
energizing the second set of stator windings with a third pulse from the power source to rotate the rotor in a first direction to the known position, and
energizing the first set of stator windings with a fourth pulse from the power source to rotate the encoder in a second direction opposite the first direction to the final position.

15. The motor control system of claim 14, wherein the first pulse causes the rotor to rotate to a first edge or to a second edge of a sector area proximate a 90° location from the desired initiation position.

16. The motor control system of claim 15, wherein the first edge is located a sweep angle equal to the friction error sweep angle from the 90° location in the second direction and the second edge is located a sweep angle equal to an amount twice the friction error sweep angle in the first direction from the first edge.

17. The motor control system of claim 14, wherein the first pulse causes the rotor to remain stationary in one of a first sector area or a second sector area proximate +/−90° from the desired initiation position.

18. The motor control system of claim 17, wherein both the first sector area and the second sector area cover a sweep angle equal to an amount twice the friction error sweep angle.

19. The motor control system of claim 18, wherein a difference between the known position and the final position is a final sweep angle equivalent to 90-degrees minus twice the friction error sweep angle.

20. A non-transitory computer-readable medium for aligning a motor to a desired initiation position, the motor having a stator and a rotor, the stator comprising a first set of stator windings and a second set of stator windings, the rotor rotatable about a motor axis, the non-transitory computer-readable medium including instructions executable by an electronic processor to perform a set of functions, the set of functions comprising:
determining, with an electronic processor, a first encoder count equivalent to a 90-degree rotation of the rotor;
energizing the stator with a power source to rotate the rotor based on the first encoder count from a known position to a final position;
determining, with the electronic processor, a friction error sweep angle equivalent to a difference between a desired initiation position and the final position of the rotor;
adjusting, with the electronic processor, the first encoder count based on the friction error sweep angle to define a second encoder count; and
starting the motor by energizing the stator with the power source to rotate the rotor based on the second encoder count.
